(19) United States
(12) Patent Application Publication
(10) Pub. No.: US 2026/0226900 A1
(43) Pub. Date: Aug. 6, 2026

(54) AXIAL GAP-TYPE ELECTRIC MOTOR INCLUDING INTEGRATED STATOR CORE, AND WATER PUMP USING SAME

(71) Applicant: AMOTECH CO., LTD., Incheon (KR)

(72) Inventor: Byung Soo KIM, Incheon (KR)

(21) Appl. No.: 19/153,959

(22) PCT Filed: Feb. 19, 2024
(86) PCT No.: PCT/KR2024/095389

§ 371 Date: Aug. 5, 2025

(30) Foreign Application Priority Data
Feb. 21, 2023 (KR) 10-2023-0023209

(51) Int. Cl. F04D 13/06; F04D 1/04; H02K 1/14; H02K 3/28; H02K 3/34; H02K 11/33

(52) U.S. Cl. CPC F04D 13/0666; F04D 1/04; F04D 13/0693; H02K 1/146; H02K 3/28; H02K 3/345; H02K 11/33; H02K 2203/03; H02K 2203/12; H02K 2211/03

(57) ABSTRACT

Provided is an axial gap-type electric motor including an integrated stator core made of soft magnetic powder (SMC), and an electric water pump using same. The electric motor includes: a rotor rotatably supported in a fluid flow passage between a pump cover and a body case; a stator arranged in an upper space formed by the body case and an upper cover while facing the rotor arranged in the fluid flow passage, the stator generating a rotating magnetic field to rotate the rotor; and a heat dissipation molding part surrounding the upper portion of the stator to waterproof and insulate the stator and integrating the stator with the body case and the upper cover. A thin film air gap forming part extending from the heat dissipation molding part is arranged on the front surface of the stator facing the rotor.

### TECHNICAL FIELD

The present invention relates to an axial gap-type electric motor, and more particularly, to an axial gap-type electric motor capable of removing a waterproof partition wall between a rotor and a stator by molding an upper portion of a stator with an insulating heat dissipation composite material, and minimizing an air gap, and an electric water pump using same.

### BACKGROUND ART

Generally, a water pump applied to a vehicle is a device for circulating cooling water. The water pump is forcibly driven by a belt to suck and discharge cooling water by rotating a pump impeller, thereby circulating cooling water. An engine-driven water pump or an electric water pump is representatively used in the inside of the water pump. The engine-driven water pump is assembled with a seal unit therein to prevent leakage of cooling water, and the electric water pump is driven by an electric motor driven by electricity provided by a battery or the like, and circulates cooling water by rotating an impeller by the electric motor to suck and discharge the cooling water.

In addition, since the electric water pump does not require the engine driving force of the vehicle compared to the engine-driven water pump, the engine efficiency is increased compared to the engine-driven water pump, and thus fuel efficiency is improved, and furthermore, the temperature of the cooling water may be precisely controlled, thereby being widely applied to various kinds of vehicles.

In addition, in the case of an electric vehicle, a hybrid vehicle, or a fuel cell vehicle, the importance of the electric water pump grows increasingly as compared with the engine-driven water pump because driving of a vehicle is executed even at a state where driving of an engine stops (in the case of a hybrid vehicle), or even an engine for driving the water pump is not provided (in the case of an electric vehicle or a fuel cell vehicle).

Meanwhile, among the electric water pumps, a canned type electric water pump is a pump driven by an electric motor having a can-shaped sealing container inside a stator. The canned type electric water pump has a structure in which a can structure is inserted between a rotor and a stator, and a hydraulic unit is extended to the rotor so that the rotor is immersed in the cooling water, thereby appropriately cooling, through the cooling water contacting the rotor, the frictional heat generated from the rotor.

In the Korean Patent Application Publication No. 10-2021-0108845 (Patent Document 1), there is provided an axial gap-type electric motor for an electric water pump (EWP) including: a rotor rotatably supported on a fluid flow passage between a pump cover and a body case; a stator arranged in a lower space formed by the body case and an upper cover, and generating a rotating magnetic field to rotatably drive the rotor; and a partition arranged on upper of the body case to separate between the rotor and the stator, wherein the rotor includes a non-rare earth magnet.

In the conventional electric motor structure of Patent Document 1, a stator core of a stator includes: a plurality of teeth each formed in a “T” shape and made of soft magnetic composites (SMC) powders; and a back yoke formed by stacking a plurality of electrical steel sheets that interconnect the plurality of teeth, so there is a problem of poor assembly productivity.

In general, electric water pumps (EWP), compressors, oil pumps, etc., employ inner rotor-type electric motors, but in the case of inner rotor-type electric motors, the cross-sectional area of magnets (i.e., effective area) is small, and thus, rare earth elements are used to implement performance, to thereby increase production costs.

In addition, the water pump motor employs an inner rotor-type motor, and the rare earth magnet (Nd—Fe—B) employed in the rotor contains iron ingredients, and thus, rust may be generated in the magnet when contacting water, so the rotor portion also adopts a waterproof structure. Accordingly, the water pump motor has a structure in which an air gap between the rotor and the stator is increased, thereby increasing the amount of Nd used in the rotor magnet.

Moreover, in the inner rotor-type motor, the inner shoe portion of the core of the stator facing the magnet of the rotor is not generally rounded or round (R)-processed, and thus the back-electromotive force (back-EMF) waveform may not be made into a sine curve, causing noise and vibration problems. That is, in general, the inside of the core is designed to form a concentric circle with respect to the center. Accordingly, the core structure of the conventional stator separately needs an auxiliary component or to be designed for improving noise and vibration problems.

In order to improve the generation of vibration and noise, conventionally, it is generally performed in a form in which a round (R) processing is applied to the magnet of the rotor. However, if the magnet is a segment structure, there is no problem, but if the magnet is an integral structure in which the magnet is split and magnetized, it is difficult to perform a rounding process to obtain a round (R) shape.

### DISCLOSURE

### Technical Problem

It is an objective of the present invention to provide an axial gap-type electric motor and a water pump using same, which has a magnetic energy equivalent to an electric motor using a rare earth magnet even if a ferrite magnet, which is a non-rare earth magnet, is used, since a waterproof partition wall between a rotor and a stator may be removed by molding an insulating heat dissipation composite material for waterproof insulating the upper portion of the stator, and it is possible to minimize an air gap therein.

It is another objective of the present invention to provide an axial gap-type electric motor and a water pump using same, which is capable of being completely waterproof in a simple structure by forming a heat dissipation molding part to surround an upper portion of a stator.

It is another objective of the present invention to provide an axial gap-type electric motor and a water pump using same, in which a core shape is optimized to minimize a core loss generated in the electric motor by manufacturing an integrated stator core with a back yoke for interconnecting a plurality of teeth and teeth by a compression molding method using SMC powders.

It is another objective of the present invention to provide an axial gap-type electric motor and a water pump using same, which can easily implement a three-phase Y-connection brushless direct-current (BLDC) motor using an auxiliary printed circuit board (PCB) by sequentially assembling an integrated stator core, a bobbin, an auxiliary PCB for coil wiring, and a plurality of coils.

### Technical Solution

According to an aspect of an embodiment of the present invention, there is provided an axial gap-type electric motor for an electric water pump (EWP) including: a rotor rotatably supported on a fluid flow passage between a pump cover and a body case; a stator arranged in an upper space formed by the body case and an upper cover while facing the rotor arranged in the fluid flow passage, the stator generating a rotating magnetic field to rotate the rotor; and a heat dissipation molding part surrounding the upper portion of the stator to waterproof and insulate the stator and integrating the stator with the body case and the upper cover, wherein a thin film air gap forming part extending from the heat dissipation molding part is arranged on the front surface of the stator facing the rotor.

The heat dissipation molding part may be filled, from the upper portion of the stator, between the inner circumference of the body case and the annular protrusion protruding from the center of the upper cover to define the fluid flow passage.

In addition, the stator includes: an integrated stator core including a plurality of teeth arranged in an annular form at intervals and an annular back yoke interconnecting the plurality of teeth to form a magnetic circuit, and made of soft magnetic composites (SMC) powders; a bobbin made of insulating material, which is coupled to an upper portion of the stator core and in which a plurality of teeth coupling joints protrude, the plurality of teeth being inserted into the plurality of teeth coupling joints; a plurality of coils assembled to an outer circumferential surfaces of the plurality of teeth coupling joints, respectively; and an auxiliary printed circuit board (PCB) having a plurality of through-holes into which the plurality of teeth-coupling joints are inserted, wherein the plurality of coils are coupled to the plurality of teeth coupling joints protruding through the plurality of through-holes when coupled to the upper portion of the bobbin so as to be mounted on an upper surface thereof, and a plurality of conductive patterns for interconnecting the plurality of coils so as to form a three-phase Y-connection-type neutral point (N) are formed on the upper surface thereof.

In this case, when the plurality of coils, that is, the three-phase (U, V, W) coils are split into and wound on nine teeth and constitute a parallel connection circuit for each phase of U, V, and W phases, the plurality of conductive patterns may include: first to third conductive patterns respectively arranged outside the auxiliary printed circuit board (PCB) and connected to start lines of the U, V, and W three-phase coils mounted on the upper surface of the auxiliary printed circuit board (PCB) so as to configure a parallel connection circuit for each phase; and a circular conductive pattern arranged around a through-hole formed in a central portion of the auxiliary printed circuit board (PCB) and having an end line of the three-phase (U, V, W) coils connected in common to form a Y-connection-type neutral point (N) of the three-phase (U, V, W) coils.

In addition, the first to third conductive patterns may be connected to the three-phase (U, V, W) output terminals of an inverter circuit included in the motor driving circuit to apply driving current to the three-phase (U, V, W) coils, respectively.

Moreover, the bobbin includes: the plurality of teeth coupling joints into which the teeth are inserted and on the outer circumferential portion of which the coils are coupled, respectively; and an annular flange connecting the plurality of teeth coupling joints, wherein each of the plurality of teeth coupling joints may have a through-hole through which a front end portion is exposed when the plurality of teeth are coupled.

The electric motor may include a BLDC motor having a three-phase Y-connection method, a 12-pole-9 slot, or an 8-pole-6 slot structure, and the plurality of coils, that is, three-phase (U, V, W) coils may be split into and wound on nine or six teeth to form a series connection circuit or a parallel connection circuit for each phase of U, V, and W phases.

According to another aspect of an embodiment of the present invention there is provided a water pump including: a pump cover in which an inlet through which a fluid is introduced and a side outlet through which the introduced fluid is discharged are connected through a fluid flow passage; a cylindrical body case coupled to a lower portion of the pump cover; an upper cover coupled to seal a lower portion of the body case to form a space inside the body case; a rotor rotatably supported above the fluid flow passage inside the body case; an impeller integrally formed with the rotor on an upper side of the rotor; a stator arranged below the fluid flow passage inside the body case to face the rotor to generate a rotating magnetic field to rotate the rotor; and a heat dissipation molding part surrounding the upper portion of the stator to waterproof and insulate the stator and integrating the stator with the body case and the upper cover, wherein a thin film air gap forming part extending from the heat dissipation molding part is arranged on the front surface of the stator facing the rotor.

In this case, the stator may include: an integrated stator core including a plurality of teeth arranged in an annular form at intervals and an annular back yoke interconnecting the plurality of teeth to form a magnetic circuit, and made of soft magnetic composites (SMC) powders; a bobbin made of insulating material, which is coupled to an upper portion of the stator core and in which a plurality of teeth coupling joints protrude, the plurality of teeth being inserted into the plurality of teeth coupling joints; a plurality of coils assembled to an outer circumferential surfaces of the plurality of teeth coupling joints, respectively; and an auxiliary printed circuit board (PCB) having a plurality of through-holes into which the plurality of teeth-coupling joints are inserted, wherein the plurality of coils are coupled to the plurality of teeth coupling joints protruding through the plurality of through-holes when coupled to the upper portion of the bobbin so as to be mounted on an upper surface thereof, and a plurality of conductive patterns for interconnecting the plurality of coils so as to form a three-phase Y-connection-type neutral point (N) are formed on the upper surface thereof.

In addition, when the plurality of coils, that is, the three-phase (U, V, W) coils are split into and wound on nine teeth and constitute a parallel connection circuit for each phase of U, V, and W phases, the plurality of conductive patterns may include: first to third conductive patterns respectively arranged outside the auxiliary printed circuit board (PCB) and connected to start lines of the three-phase (U, V, W) coils mounted on the upper surface of the auxiliary printed circuit board (PCB) so as to configure a parallel connection circuit for each phase; and a circular conductive pattern arranged around a through-hole formed in a central portion of the auxiliary printed circuit board (PCB) and having an end line of the three-phase (U, V, W) coils connected in common to form a Y-connection-type neutral point (N) of the three-phase (U, V, W) coils.

Moreover, the bobbin includes: the plurality of teeth coupling joints into which the teeth are inserted and on the outer circumferential portion of which the coils are coupled, respectively; and an annular flange connecting the plurality of teeth coupling joints, wherein each of the plurality of teeth coupling joints may have a through-hole through which a front end portion is exposed when the plurality of teeth are coupled.

The heat dissipation molding part may be filled, from the upper portion of the stator, between the inner circumference of the body case and the annular protrusion protruding from the center of the upper cover to define the fluid flow passage.

In addition, the water pump according to the embodiment of the present invention may further include: a support shaft having a lower end portion fixed to the upper cover through a groove inside an annular protrusion protruding from a center of the upper cover; a bearing housing extending from the center of the rotor support supporting the rotor to the inside of the groove of the annular protrusion; a sleeve bearing installed at an inner circumferential portion of the bearing housing to rotatably support the rotor about the support shaft.

The magnet of the rotor may be an open structure exposed to the fluid, and the magnet of the rotor may be a ferrite magnet.

### Advantageous Effects

As described above, in the present invention, by molding the upper portion of the stator with the insulating heat dissipation composite material, the waterproof partition wall between the rotor and the stator may be removed, and the air gap may be minimized, so that even if a ferrite magnet, which is a non-rare earth magnet, is used, a magnetic energy equivalent to a magnetic energy of an electric motor using the rare earth magnet including Nd may be used.

In addition, in the present invention, the waterproof partition wall placed between the conventional rotor and stator may be removed by forming a heat dissipation molding part made of an insulating heat dissipation composite material that may increase insulation and heat dissipation performance to surround the upper portion of the stator. As a result, it is possible to minimize the air gap between the rotor and the stator, so that a ferrite magnet, which is a non-rare earth magnet, may be used.

In the present invention, the partition wall of the thin film is integrally formed together with the body case, but the body case is simply formed by removing the partition wall, and the rotor and the stator may be implemented to have a complete waterproof structure.

Moreover, the electric motor of the present invention is an axial gap-type electric motor in which a rotor and a stator face each other, and a ferrite magnet that does not generate rust may be used, and thus the electric motor of the present invention may be used as an open structure without the need for a separate magnet waterproof structure such as a rare earth magnet. Therefore, by omitting the magnet waterproof structure, the air gap may be further reduced than the conventional electric motor employing rare earth magnets to increase motor efficiency.

In the axial gap-type electric motor of the present invention, a back yoke interconnecting a plurality of teeth and teeth is manufactured into an integrated stator core by a compression molding method using SMC powders together with teeth, thereby solving the problem of low productivity in the assembly of a back yoke including a plurality of SMC teeth and an electric steel sheet (S-60), and optimizing a core shape to minimize the core loss generated by the electric motor.

In addition, in the present invention, by sequentially assembling an integrated stator core, a bobbin, a coil connection auxiliary printed circuit board (PCB), and a plurality of coils, a three-phase Y-connection BLDC motor may be easily implemented using the auxiliary printed circuit board (PCB), and assembly productivity may be increased.

### BRIEF DESCRIPTION OF THE DRAWINGS

FIG. 1 is a perspective view of a water pump using an axial gap-type electric motor according to an embodiment of the present invention.

FIG. 2 is a front view of a water pump using an axial gap-type electric motor according to an embodiment of the present invention.

FIG. 3 is a cross-sectional view of line A-A of FIG. 2.

FIG. 4 is a plan view of a water pump using an axial gap-type electric motor according to an embodiment of the present invention.

FIGS. 5 and 6 are cross-sectional views taken along lines B-B and C-C of FIG. 4, respectively.

FIG. 7 is an exploded perspective view of each assembly of a water pump using an axial gap-type electric motor according to an embodiment of the present invention.

FIGS. 8A to 8C are a perspective view, a cross-sectional view in a diameter direction, and an exploded perspective view of a stator for an axial gap-type electric motor according to an embodiment of the present invention, respectively.

FIGS. 9 and 10 are equivalent circuit diagrams of an auxiliary PCB and a stator coil of a stator according to an embodiment of the present invention, respectively.

### BEST MODE FOR CARRYING OUT THE INVENTION

Hereinafter, embodiments of the present disclosure will be described in detail with reference to the accompanying drawings.

The sizes and shapes of the components shown in the drawings may be exaggerated for clarity and convenience. In addition, terms defined in consideration of the configuration and operation of the present disclosure may vary depending on the intention or custom of the user, the operator, and the like. Definitions of these terms should be based on the content of this specification.

In the present invention, by molding the upper portion of a stator with an insulating heat dissipation composite material, it is possible to further reduce an air gap by separating a rotor from the stator, thereby having the same magnetic energy as an electric motor using a rare earth magnet including Nd even if a ferrite magnet, which is a non-rare earth magnet, is used.

An axial gap-type motor employing a rare-earth-free magnet according to an embodiment of the present invention may be implemented as a longitudinal-axis type motor, and is applied to a water pump (EWP), a compressor, an oil pump, etc., containing the motor therein, and an example in the following description will be described with respect to the case in which the axial gap-type motor is applied to the water pump (EWP).

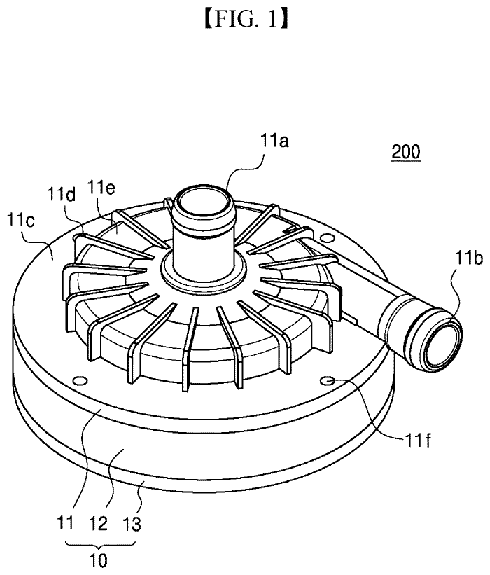

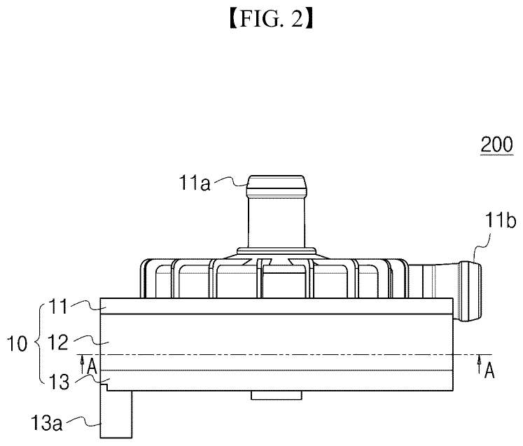

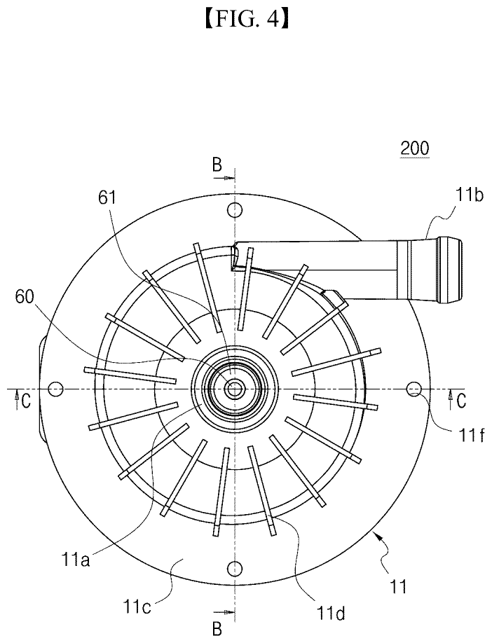

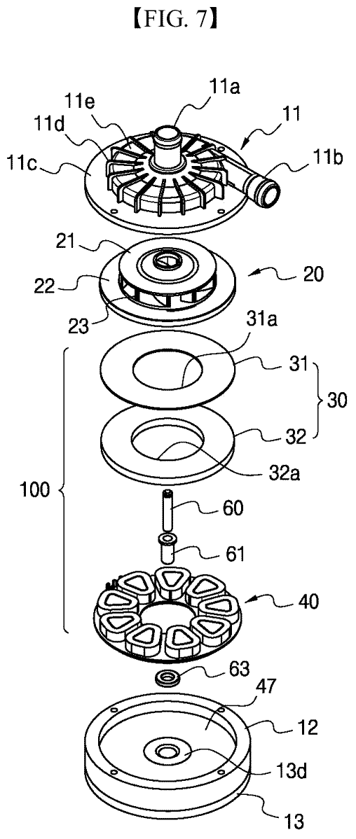

Referring to FIGS. 1 to 7, a water pump (EWP) 200 using an axial gap-type electric motor according to an embodiment of the present invention includes a pump housing 10, an impeller 20, and an axial gap-type electric motor 100.

The pump housing 10 includes: a pump cover 11 at the center of one side end of which an inlet 11a through which a fluid such as cooling water is introduced is arranged, at one side of which an outlet 11b through which the introduced fluid is discharged is extended, and the center of the other end of which is open; a body case 12 forming a fluid flow passage P in the pump cover 11 by covering the opening of the pump cover 11 using a stator 40 having a heat dissipation molding portion 47 formed thereon, and an upper cover 13 coupled to a lower side of the body case 12 to form a sealed space therein, and to the central portion of which a lower end portion of a support shaft 60, which is required when the rotor 30 rotates, is fixed.

In the present invention, a driver for driving the stator 40 may be arranged outside the pump housing 10 to form a slim water pump 200. However, the driver may be arranged inside the pump housing 10.

The pump cover 11 and the body case 12 preferably have a cylindrical shape and have a coupling structure fixed to each other. For mutual fixing and coupling between the pump cover 11 and the body case 12, for example, four fixing screws or fixing bolts are respectively fastened to coupling holes 11f formed in the outer circumferential portions of the pump cover 11 and the body case 12.

In addition, a sealing O-ring may be inserted into a bonding portion where the pump cover 11 and the body case 12 are bonded to each other.

Moreover, a plurality of fixing screws or fixing bolts may be used between the body case 12 and the upper cover 13 such that the body case 12 and the upper cover 13 are fixed and coupled to each other, and a sealing O-ring may be inserted between the body case 12 and the upper cover 13 to maintain a sealed state of the sealed space.

In addition, an annular first groove 13b on which an auxiliary printed circuit board (PCB) 55 and a bobbin 43 are seated and an annular second groove 13c in which an annular back yoke 42 of the stator 40 are seated and accommodated are formed on an upper surface of the upper cover 13.

Further, an annular protrusion 13d is formed to protrude from the center of the upper surface of the upper cover 13 so as to form a groove 13e in which a thrust bearing 63 is accommodated.

Further, a connector housing 13a for applying a driving signal from a driver (a motor driving circuit) arranged outside to an external terminal 55c of the auxiliary printed circuit board (PCB) 55 is integrally extended below one side of the upper cover 13.

The pump cover 11, the body case 12, and the upper cover 13 forming the pump housing 10 may be formed of, for example, a resin such as polyphenylene sulfide (PPS).

The impeller 20 in which the rotor 30 of the electric motor 100 is integrally formed at the lower side of the fluid flow passage P is arranged in the fluid flow passage P of the 90-degree bent portion between the inlet 11a and the outlet 11b of the pump cover 11.

In addition, the open lower end of the pump cover 11 is extended to secure a larger space than the inlet 11a so that the impeller 20 may be arranged in the fluid flow passage P, and a groove structure is formed so that the rotor 30 integrally formed on the lower side of the impeller 20 may be arranged above the body case 12 corresponding to the open lower end of the pump cover 11.

In the impeller 20, a plurality of wings 23 are radially arranged between an annular upper plate 21 and a circular lower plate 22 to discharge a fluid such as cooling water introduced from the inlet 11a through the outlet 11b arranged at the side surface of the pump cover 11. The upper plate 21 has a through-hole formed in the center thereof, and has a narrow-upper-wide-lower tapered shape with a diameter increasing from the upper side of the upper plate 21 to the lower side thereof, and the lower plate 22 includes a circular plate integrally formed with the upper side of the rotor support 33 supporting the rotor 20.

The pump cover 11 has a flange 11c extending on the lower end portion thereof from a body 11e accommodating the impeller 20 therein so as to have the same outer diameter as the outer diameter of the body case 12. A plurality of strength reinforcing ribs 11d are radially protruded from an outer circumferential surface of the body 11e to reinforce the strength of the body 11e.

Accordingly, the lower plate 22 has a diameter larger than that of the upper plate 21 in correspondence to the diameter of the flange 11c, so that the outer circumference of the lower plate 22 surrounds the outer circumference of the rotor 30. In this case, the lower plate 22 and the rotor 30 may be integrated by an insert molding method when the lower plate 22 and the rotor 30 are formed using, for example, a resin such as poly polyphenylene sulfide (PPS).

In addition, a bearing housing 62 protrudes downward in the centers of the lower plate 22 and the rotor support 33, and a sleeve bearing 61 is installed in the bearing housing 62 to rotatably support the rotor 30 on the support shaft 60. A groove 60a is formed on the upper portion of the support shaft 60 so that a snap ring is coupled to the groove 60a to prevent the sleeve bearing 61 and the rotor 30 from separating.

It is desirable to use an oil-less bearing, such as a carbon bearing or a plastic bearing in consideration of the fact that the sleeve bearing 61 is in contact with the fluid.

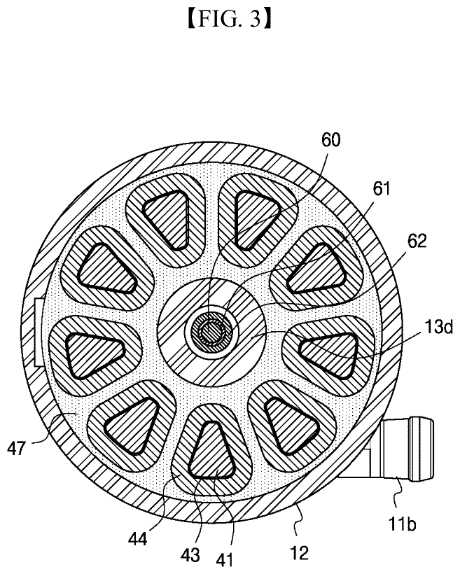

Meanwhile, as shown in FIGS. 3 to 8C, the water pump (EWP) 200 of the present invention employs, as a driving means for rotating the impeller 20, the axial gap-type electric motor 100 including the core-type stator 40 integrated with the body case 12 inside the body case 12 and the rotor 30 arranged to face the stator 40 in a fluid flow passage (P) above the core-type stator 40.

First, the rotor 30 has the ring-shaped back yoke 31 and the magnet 32 installed sequentially on the lower surface of the lower plate 22 to form a single body with the impeller 20. The magnet 32 of the rotor 30 may include a plurality of N-pole and S-pole split magnet segments, or may use a magnet in which the N-pole and S-pole are split and magnetized into multiple poles in a ring-shaped magnet. The back yoke 31 may be, for example, an electro galvanized iron (EGI) steel sheet, and is installed on the rear surface of the magnet 32 to form a magnetic circuit. Through-holes 31a and 32a are formed in the centers of the back yoke 31 and the magnet 32, respectively.

The rotor 30 is integrally formed with the lower plate 22 of the impeller 20 so that the rotor support 33 surrounding the upper portion and the side surface of the back yoke 31 and the magnet 32 is integrally formed with the lower plate 22 of the impeller 20 to form a single body.

Conventionally, the partition wall of the thin plate for separating the stator 40 and the rotor 30 is integrally formed in the body case 12, and the stator 40 is arranged in the sealed lower space inside the body case 12 to prevent the stator 40 from coming into contact with the cooling water.

In the present invention, instead of integrally forming, inside the body case 12, a partition wall of an artificial thin plate for separating the stator 40 and the rotor 30, a waterproof molding part 47 is formed on the upper surface of the stator 40 to implement a perfect waterproof structure.

As described below, in the present invention, an air gap forming part 47a of the waterproof molding part 47 formed on the upper surface of the teeth 41 of the stator 40 arranged to face the magnet 32 of the rotor 30 may include a thin film.

As a result, the air gap between the stator 40 and the rotor 30 may be further reduced, so that a ferrite magnet, which is a non-rare earth magnet, may be used as the magnet of the rotor 30.

In other words, the electric motor 100 of the present invention has an axial gap-type in which the rotor 30 and the stator 40 face each other with the thin air gap forming part 47a therebetween, and may be used as an open structure in which cooling water contacts the magnet without the need for a separate magnet waterproof structure when using a rare earth magnet.

In this case, as the electric motor 100 according to the present invention uses a ferrite magnet as the magnet 32 of the rotor 30, which is a non-rare earth magnet that does not rust, the performance the magnet does not deteriorate even if the ferrite magnet is operated for a long time in contact with the cooling water flowing along the fluid flow passage (P) inside the pump cover 11. Accordingly, the electric motor 100 of the present invention may further reduce an air gap compared to an electric motor employing a rare earth magnet having a magnet waterproof structure to thereby increase efficiency of the motor.

In addition, in the present invention, when a vertical type electric motor having the same outer diameter as a general internal electric motor is applied, it is possible to reduce an air gap by separating the rotor 30 and the stator 40 from each other by using the thin film air gap forming part 47a between the rotor 30 and the stator 40, thereby implementing an axial gap-type electric motor having magnetic energy equivalent to that of an electric motor using a rare earth magnet including Nd even if a ferrite magnet, which is a non-rare earth magnet, is used.

Furthermore, when an artificial thin plate partition wall to separate the stator 40 and the rotor 30 from each other is integrally formed inside the body case 12 in the past, injection molding of the body case 12 with such a thin plate partition wall is not easy.

In this invention, instead of injection molding the partition wall of the thin plate integrally with the body case 12, the body case 12 may be easily manufactured by forming a waterproof molding part 47 with a thin air gap forming part 47a on the upper surface of the stator 40.

The support shaft 60 may be integrated by an insert molding method in which the lower end portion of the support shaft 60 is inserted into the center of the groove 13e of the annular protrusion 13d during injection molding of the upper cover 13 or may be press-fitted into and fixed to the groove 13e formed inside the annular protrusion 13d.

A thrust bearing 63 is installed under the groove 13e to minimize frictional resistance when the lower end portion of the sleeve bearing 61 rotates with the rotor 30, and the lower end portion of the support shaft 60 is fixed to the upper cover 13 through the through-hole of the thrust bearing 63.

In this case, the lower ends of the sleeve bearing 61 and the bearing housing 62 extend to the groove 13e of the annular protrusion 13d and are rotatably coupled to the outer circumference of the support shaft 60 with sufficient contact area, so as to stably support the rotor 30 and the impeller 20.

Hereinafter, the stator of an axial gap-type electric motor according to an embodiment of the present invention will be described.

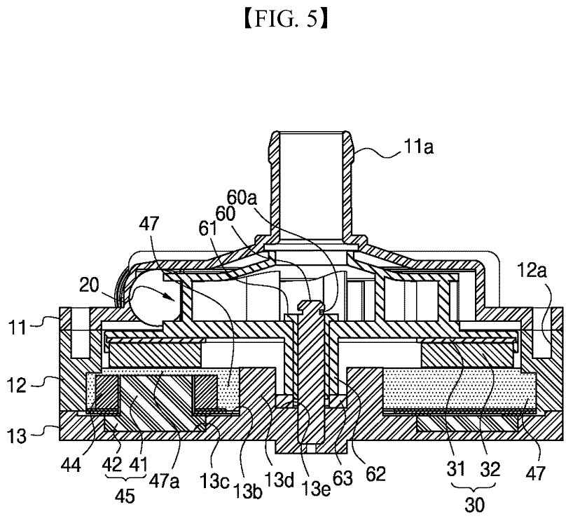

As shown in FIGS. 5 to 8C, the stator 40 is arranged to face the rotor 30 in the axial direction with the air gap forming part 47a of the thin film therebetween to form an axial gap-type electric motor 100.

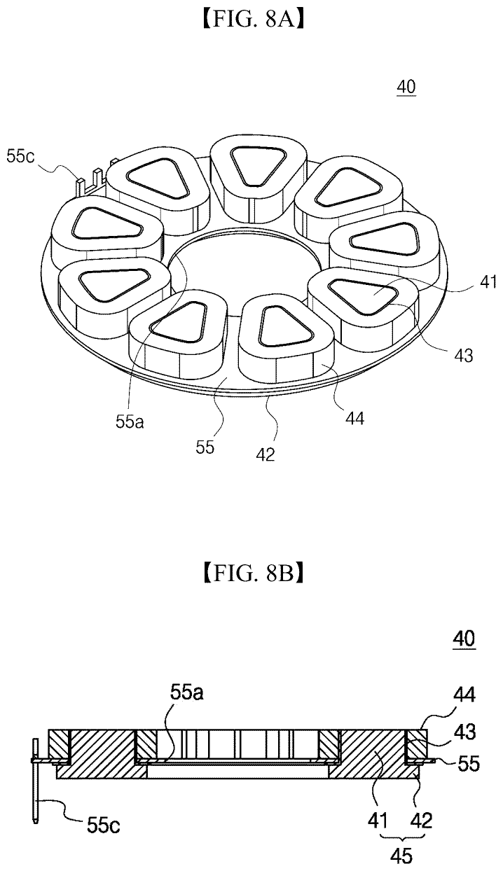

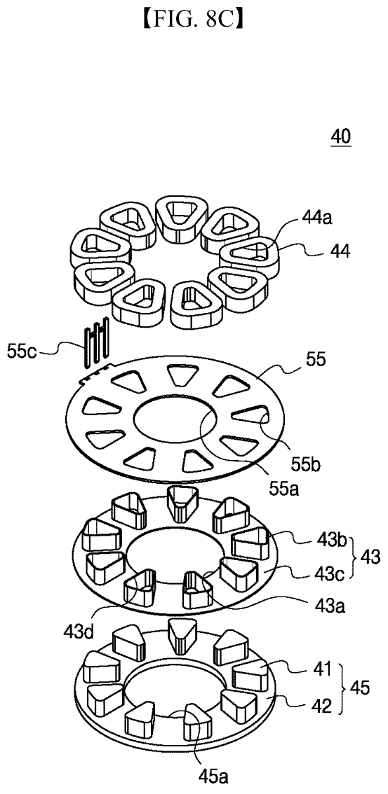

As shown in FIGS. 8A to 8C, the stator 40 includes: an integrated stator core 45 integrally equipped with a plurality of teeth 41 protruding in the axial direction and an annular back yoke 42 that forms a magnetic circuit by interconnecting the plurality of teeth 41; a plurality of teeth coupling joints 43b coupled to the outside of the plurality of teeth 41 so as to surround the outer circumferential surface to which the coils of each of the plurality of teeth 41 are wound; an integrated bobbin 43 made of an insulating material, which is provided with an annular flange 43c connecting the plurality of teeth coupling joints 43b; an auxiliary printed circuit board (PCB) 55 in which a plurality of through-holes 55b corresponding to the plurality of teeth coupling joints 43b are radially arranged on the same circumference, and assembled on the upper portion of the bobbin 43; and a plurality of coils 44 wound around the outer circumferential surface of the plurality of teeth coupling joints 43b protruding through the plurality of through-holes 55b of the auxiliary printed circuit board (PCB) 55.

In this case, each of the plurality of teeth coupling joints 43b includes a through-hole 43d through which a front end portion of each of the plurality of teeth 41 is exposed.

In addition, instead of the integrated bobbin, the bobbin 43 may include a plurality of bobbins of an insulating material with a plurality of teeth coupling joints 43b and a flange 43c coupled to the outside of the plurality of teeth 41.

The stator core 45, the bobbin 43, and the auxiliary printed circuit board (PCB) 55 all have through-holes 45a, 43a, and 55a formed in the central portions thereof, respectively.

The stator core 45 includes an annular back yoke 42 and a plurality of teeth 41 that protrude radially integrally on the same circumference in a perpendicular direction to the back yoke 42 on one surface of the back yoke 42, and may be manufactured by compressing and molding soft magnetic composites (SMC) powders.

The plurality of teeth 41 are annularly arranged parallel to the axial direction on the same circumference so that the front end portions of the plurality of teeth 41 are arranged to face the magnet 32 of the rotor 30.

The stator core 45 may adopt an isotropic magnetic material having high magnetic permeability, low coercive force, and high saturated magnetic induction as the soft magnetic composites (SMC) powders, for example, powders of alloy, such as Fe—Ni, Fe—Co, and Fe—Si. When the stator core 45 are manufactured using such soft magnetic composites (SMC) powders by a compression molding or extrusion molding method, the stator core 45 may be formed in a 3D structure and the stator core 45 may have an isotropic property.

In this invention, since a T-type shoe is not formed at the front end portion of the teeth 41 with soft magnetic composites (SMC) powders, it is not necessary to form a rounding (R) required for curved surfaces in the shoe portion to obtain a sine curve back electromotive force (EMF) waveform to prevent generation of noise and vibration during electric motor rotation.

In addition to compression molding of the soft magnetic composites (SMC) powder, the stator core 45 of the present invention may be molded by mixing amorphous metal powder having a high permeability with a binder, or may be molded by mixing amorphous metal powder, spherical soft magnetic composites (SMC) powder, and a binder at a predetermined ratio. In this case, when the spherical soft magnetic composites (SMC) powder is mixed at a predetermined ratio as compared with the case where 100% of the amorphous metal powder is used, the difficulty of high-pressure sintering can be solved and the permeability can be increased.

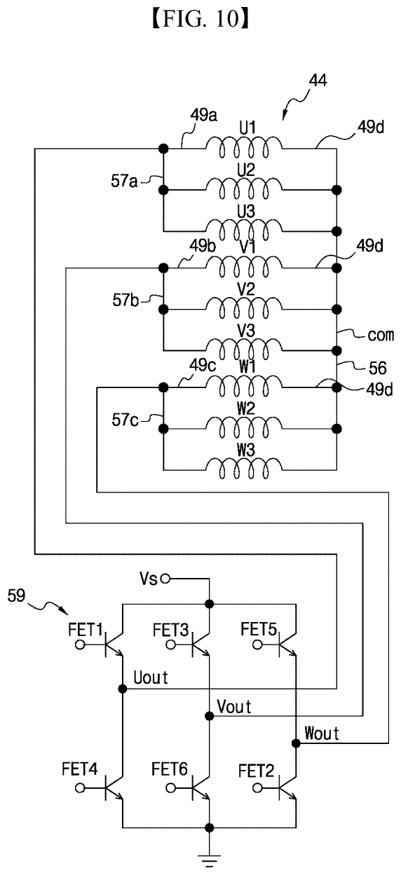

The plurality of coils 44 are mounted on the auxiliary printed circuit board (PCB) 55 arranged below, and when the electric motor 100 has three-phase (U, V, W) coils, for example, as shown in FIG. 10, the Y-connection neutral point (N) may be easily formed using the auxiliary printed circuit board (PCB) 55.

The stator 40 may increase assembly productivity by sequentially assembling the stator core 45, the bobbin 43, the auxiliary printed circuit board (PCB) 55 and the plurality of coils 44 from the lower. Furthermore, each of the plurality of coils 44 is pre-wound into a bobbinless type and then coupled to the outer circumference of the plurality of teeth coupling joints 43b protruding through the plurality of through-holes 55b, and may be easily mounted on the upper portion of the auxiliary printed circuit board (PCB) 55.

In this case, the teeth 41, the teeth coupling joints 43b, the through-holes 55b, and the coils 44 are all fan-shaped, and the plurality of coils 44 also have fan-shaped through-holes 44a therein.

In the water pump 200 according to the present invention, the axial gap-type electric motor 100 may be composed of, for example, a brushless direct-current (BLDC) motor having a 12-pole-9-slot or 8-pole-6-slot structure. When the electric motor 100 has a 12-pole-9 slot structure, a plurality of coils 44 of the stator 40 are formed of nine coils as shown in FIG. 10, and the nine U1 to U3, V1 to V3, and W1 to W3 coils 44 are individually wound in a bobbinless type in advance, and may be mounted on the upper surface of the auxiliary printed circuit board (PCB) 55 after being press-fitted and coupled to the outer circumferences of a plurality of teeth coupling joints 43b protruding upward through the nine through-holes 55b of the auxiliary printed circuit board (PCB) 55.

In this case, the nine U1 to U3, V1 to V3, and W1 to W3 coils 44 are arranged in three windings for each phase of U, V, and W phases, and the three coils of each of U1 to U3, V1 to V3, and W1 to W3 coils 44 arranged for respective phases may be connected in series or connected in parallel as shown in FIG. 10.

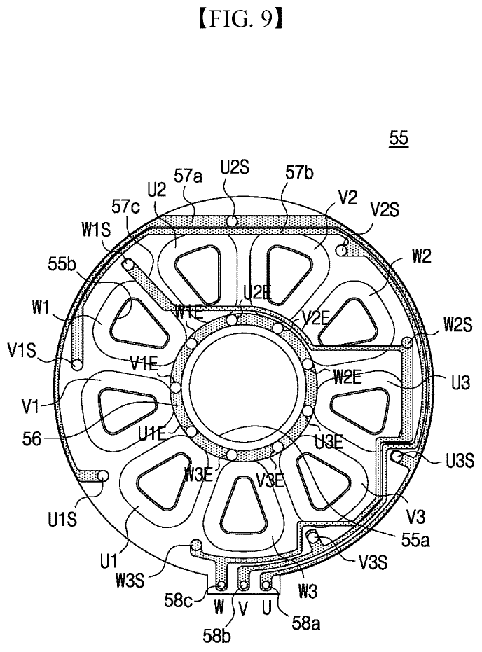

The equivalent circuit diagram of the stator coil 44 shown in FIG. 10 shows that three coils of each phase of the U1 to U3, V1 to V3, and W1 to W3 coils 44 arranged for the respective U, V, and W phases are connected in parallel and coupled in a Y-connection method to form a neutral point (N), and FIG. 9 shows a pattern diagram of conductive patterns 56, and 57a to 57c formed on the upper surface of the auxiliary printed circuit board (PCB) 55 to implement an equivalent circuit of the stator coil 44 connected in parallel shown in FIG. 10.

As shown in FIG. 10, since the coils U1 to U3, V1 to V3, and W1 to W3 of each phase are connected in parallel, the start lines 49a-49c of each of the phase coils U1 to U3, V1 to V3, and W1 to W3 are interconnected, and the end lines 49d of all coils U1 to U3, V1 to V3, and W1 to W3 are interconnected to form the neutral point COM of the Y-connection method.

To this end, the auxiliary printed circuit board (PCB) 55 is formed in an annular shape as shown in FIG. 9, and a circular conductive pattern 56 and three U-phase, V-phase, and W-phase conductive patterns 57a to 57c are formed around the through-hole 55a formed in the center portion thereof.

In the U-phase, V-phase, and W-phase conductive patterns 57a to 57c, the U-phase conductive pattern 57a is first arranged along the outermost edge of the auxiliary printed circuit board (PCB) 55, the V-phase conductive pattern 57b is arranged inside the U-phase conductive pattern 57a, and the W-phase conductive pattern 57c is partially arranged along the inside of the V-phase conductive pattern 57b after passing across the inside of the auxiliary printed circuit board (PCB) 55.

The U1 to U3, V1 to V3, and W1 to W3 coils 44 have U-phase, V-phase, and W-phase coils alternately arranged along the substrate direction. The start lines 49a to 49c of the U1 to U3, V1 to V3, and W1 to W3 coils 44 are connected to the first to third start terminals (U1S, U2S, U3S; V1S, V2S, V3S; and W1S, W2S, W3S) of the U-phase, V-phase, and W-phase conductive patterns 57a to 57c placed outside the substrate. The end lines 49d of the U1 to U3, V1 to V3, and W1 to W3 coils 44 are each placed inside the substrate to form a Y-connection line (neutral point), and connected to the first to third end terminals U1E, U2E, U3E; V1E, V2E, V3E; and V1E, V2E, V3E) of the circular conductive pattern 56 forming the common electrode COM.

In addition, the other ends of the U-phase, V-phase, and W-phase conductive patterns 57a to 57c are respectively connected to the three-phase (U, V, W) output terminals (Uout, Vout, and Wout) of the inverter circuit 59 provided in the motor driving circuit (driver) outside the water pump (EWP) 200 through the external terminal 55c, which has one end coupled to the U-phase, V-phase, and W-phase external connection terminals 58a to 58c arranged on one side of the auxiliary printed circuit board (PCB) 55.

Therefore, the Y-connection neutral point (N) of the three-phase (U, V, W) coils required to implement a three-phase Y-connection BLDC motor may be easily implemented using the U-phase, V-phase, and W-phase conductive patterns 57a to 57c and circular conductive patterns 56 formed on the upper portion of the auxiliary printed circuit board (PCB) 55.

Further, the electric motor 100 may be driven by a 6-step full-wave driving method using an inverter circuit, for example.

When the axial gap-type electric motor 100 is driven in a three-phase (U, V, W) driving system, for example, the rotation position of the rotor 130 may be sensed using a Hall sensor as a rotor position sensing element. To this end, when the rotor 30 rotates, the rotation position of the rotor 30 may be sensed by a Hall sensor assembly including a Hall sensor installed in the auxiliary printed circuit board (PCB) 55. The rotor position sensing element for sensing the position signal of the rotor may use, for example, two or three Hall sensors, in the three-phase driving system. The Hall sensor assembly may have a structure in which three Hall sensors and peripheral circuit elements are mounted on an auxiliary printed circuit board (PCB) 55.

In addition, the axial gap-type electric motor 100 may use a sensorless type motor driving circuit without using a Hall sensor.

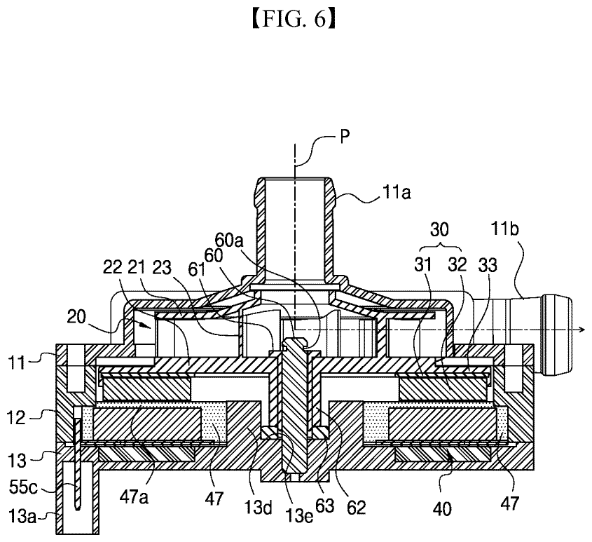

As shown in FIGS. 5 and 6, the stator 40 obtained as described above then assembles the body case 12 on the upper portion of the upper case 13 with the back yoke 42 seated in the second groove 13c of the upper case 13 and the bobbin 43 and the auxiliary printed circuit board (PCB) 55 seated in the first groove 13b to suppress the movement of the stator 40.

Thereafter, in a state in which the stator 40 is temporarily assembled inside the body case 12 and the upper case 13, an insert molding method is performed by using an insulating heat dissipation composite material capable of increasing insulation and heat dissipation performance while surrounding the upper portion of the stator 40 to form the heat dissipation molding part 47.

In this case, the heat dissipation molding part 47 is filled between the stator 40 and the body case 12 while surrounding the upper portion of the stator 40, and the heat dissipation molding part 47 is filled between the outer circumferential portion of the annular protrusion part 13d of the upper case 13 and the stator 40, thereby integrating the stator 40, the body case 12, and the upper case 13.

In addition, an air gap forming part 47a of a thin film is formed on the upper surface of the teeth 41 in the stator 40 arranged to face the magnet 32 of the rotor 30.

Furthermore, since the back yoke 42 and the plurality of teeth 41 protruding from the upper portions of the back yoke 42 are manufactured by compression-molding the soft magnetic composites (SMC) powders, rust does not occur even in contact with the fluid of the fluid flow passage P.

As a result, in the present invention, the thin-film air gap forming part 47a is not formed on the upper surface of the teeth 41 in the stator 40, and the teeth 41 may be exposed in a state capable of contacting the fluid in the fluid flow passage P.

As described above, in the present invention, the air gap of the electric motor 100 forming the BLDC motor may be further reduced by arranging the thin film air gap forming part 47a forming a portion of the heat dissipation molding part 47 between the stator 40 and the rotor 30, thereby improving efficiency.

The heat dissipation molding part 47 surrounding the stator 40 may preferably include an insulating heat dissipation composite material having heat dissipation performance and insulating performance at the same time. In this case, it is possible to use general plastic as a molding material surrounding the stator 40.

The stator 40 preferably has an insulation performance of at least 10 Kv or more, and the thermal conductivity is preferably 3 W/mK or more in consideration of heat dissipation characteristics.

Considering the above, the insulating heat dissipation composite material used in this invention may include a polymer matrix with a continuous use temperature of about 150° C. or higher and serving as a binder, an insulating heat dissipation filler made of ceramic added and dispersed to improve thermal conductivity, and a reinforcing fiber added to reinforce strength.

The polymer matrix may include one compound, a mixture of two or more thereof, or a copolymer thereof, selected from the group consisting of polyamide, polyester, polyketone, liquid crystal polymer, polyolefin, polyphenylene sulfide (PPS), polyether ether ketone (PEEK), polyphenylene oxide (PPO), polyethersulfone (PES), polyetherimide (PEI), and polyimide.

In this case, the polymer matrix may have a continuous use temperature of about 150° C. or higher, and, for example, may employ polyphenylene sulfide (PPS).

In addition, the insulating heat dissipation filler may be provided in an amount of about 75 to about 100 parts by weight based on about 100 parts by weight of the polymer matrix.

In addition, the insulating heat dissipation filler may include at least one selected from the group consisting of magnesium oxide, talc, titanium dioxide, aluminum nitride, silicon nitride, boron nitride, aluminum oxide, silica, zinc oxide, barium titanate, strontium titanate, beryllium oxide, silicon carbide, and manganese oxide.

An average particle diameter of the insulating heat dissipation filler may be approximately 10 nm to 600 μm.

Furthermore, the reinforcing fiber may be provided in an amount of about 30 parts by weight based on about 100 parts by weight of the polymer matrix, and for example, glass fibers and the like may be used.

In addition, the insulating heat dissipation composite material may further include at least one additive selected from the group consisting of a dispersant, an antioxidant, a work enhancer, a coupling agent, a stabilizer, a flame retardant, a pigment, and an impact modifier.

Bulk Molding Compound (BMC), which is a thermosetting plastic material, may be used as the insulating heat dissipation composite material. BMC is manufactured by uniformly mixing (compounding) a filler, etc. with unsaturated polyester resin using a kneader, and then impregnating the raw material with 6 mm of glass fiber, thereby aging the produced raw material for a certain period of time.

A driver for generating a rotating magnetic field by applying a driving signal to the three-phase coil 44 of the stator 40 may be installed under the stator 40, but it is omitted for slimming in the drawings of the present embodiment, and the driver is installed outside.

As described above, in the axial gap-type electric motor 100 for the water pump 200 according to the present invention, arranges the thin film air gap forming part 47a forming a portion of the heat dissipation molding part 47 for waterproof-insulating the upper portion of the stator 40 between the stator 40 and the rotor 30, and as the rotor 30 is integrally formed with the impeller 20 and arranged in the fluid flow passage P, the stator 40 and the rotor 30 have a structure separated by the thin-film air gap forming part 47a.

It is possible to remove the conventional partition wall of the waterproof thin plate integrated with the body case between the rotor and the stator, and it is possible to further minimize the air gap, so even if a ferrite magnet, which is a non-rare earth magnet, is used, a magnetic energy equivalent to a magnetic energy of an electric motor using the rare earth magnet may be used to thereby improve the efficiency of the electric motor.

In addition, when the water pump control signal is applied to the driver from the control device of the water pump 200 placed inside the vehicle, in the axial gap-type electric motor 100, the driver applies the driving signal for the stator coil 44 of the axial gap-type electric motor 100 from the driver when receiving the rotor position signal from the Hall sensor (not shown), and the stator 40 generates a rotating magnetic field from the plurality of teeth 41.

When a rotational magnetic field is generated from the plurality of teeth 41 of the stator 40, the rotor 30 arranged in the fluid flow passage P through the air gap forming part 47a of the thin film rotates around the support shaft 60 together with the impeller 20. As a result, cooling water is introduced from the inlet 11a of the pump cover 11 according to the rotation of the impeller 20, and the introduced cooling water is discharged to the outlet 11b along the fluid flow passage P.

In addition, in the present invention, the stator 40 itself is completely waterproof by forming a heat dissipation molding part 47 on the stator 40 being in contact with the fluid flow passage P, and the stator 40 may drive the impeller 20 and the rotor 30 arranged inside the fluid flow passage P in a magnetically coupled manner.

While the present disclosure has been particularly shown and described with reference to exemplary embodiments thereof, by way of illustration and example only, it is clearly understood that the present disclosure is not to be construed as limiting the present disclosure, and various changes and modifications may be made by those skilled in the art within the protective scope of the invention without departing off the spirit of the present disclosure.

### INDUSTRIAL APPLICABILITY

This invention relates to an axial gap-type electric motor, and in particular, the electric motor may be applied to hybrid, electric, and fuel cell vehicles, and may be applied to electric water pumps (EWP), compressors, and oil pumps for cooling devices that circulate cooling water in electronic components, batteries, and fuel cell stacks.

What is claimed is:

1. An axial gap-type electric motor comprising:
a rotor rotatably supported on a fluid flow passage between a pump cover and a body case;
a stator arranged in an upper space formed by the body case and an upper cover while facing the rotor arranged in the fluid flow passage, the stator generating a rotating magnetic field to rotate the rotor; and
a heat dissipation molding part surrounding the upper portion of the stator to waterproof and insulate the stator and integrating the stator with the body case and the upper cover, wherein
an air gap forming part of a thin film extending from the heat dissipation molding part is arranged on a front surface of the stator facing the rotor.

2. The axial gap-type electric motor of claim 1, wherein the heat dissipation molding part is filled, from the upper portion of the stator, between the inner circumference of the body case and the annular protrusion protruding from the center of the upper cover to define the fluid flow passage.

3. The axial gap-type electric motor of claim 1, wherein the stator comprises:
an integrated stator core including a plurality of teeth arranged in an annular form at intervals and an annular back yoke interconnecting the plurality of teeth to form a magnetic circuit, and made of soft magnetic composites (SMC) powders;
a bobbin made of insulating material, which is coupled to an upper portion of the stator core and in which a plurality of teeth coupling joints protrude, the plurality of teeth being inserted into the plurality of teeth coupling joints;
a plurality of coils assembled to an outer circumferential surfaces of the plurality of teeth coupling joints, respectively; and
an auxiliary printed circuit board (PCB) having a plurality of through-holes into which the plurality of teeth-coupling joints are inserted, wherein the plurality of coils are coupled to the plurality of teeth coupling joints protruding through the plurality of through-holes when coupled to the upper portion of the bobbin so as to be mounted on an upper surface thereof, and a plurality of conductive patterns for interconnecting the plurality of coils so as to form a three-phase Y-connection-type neutral point (N) are formed on the upper surface thereof.

4. The axial gap-type electric motor of claim 3, wherein, when the plurality of coils, that is, the three-phase (U, V, W) coils are split into and wound on nine teeth and constitute a parallel connection circuit for each phase of U, V, and W phases, the plurality of conductive patterns comprise:
first to third conductive patterns respectively arranged outside the auxiliary printed circuit board (PCB) and connected to start lines of the three-phase (U, V, W) coils mounted on the upper surface of the auxiliary printed circuit board (PCB) so as to configure a parallel connection circuit for each phase; and
a circular conductive pattern arranged around a through-hole formed in a central portion of the auxiliary printed circuit board (PCB) and having an end line of the three-phase (U, V, W) coils connected in common to form a Y-connection-type neutral point (N) of the three-phase (U, V, W) coils.

5. The axial gap-type electric motor of claim 4, wherein the first to third conductive patterns are connected to the three-phase (U, V, W) output terminals of an inverter circuit included in the motor driving circuit to apply driving current to the three-phase (U, V, W) coils, respectively.

6. The axial gap-type electric motor of claim 3, wherein the bobbin comprises:
the plurality of teeth coupling joints into which the teeth are inserted and on the outer circumferential portion of which the coils are coupled, respectively; and
an annular flange connecting the plurality of teeth coupling joints, wherein
each of the plurality of teeth coupling joints has a through-hole through which the front end is exposed when the plurality of teeth are coupled.

7. The axial gap-type electric motor of claim 1, wherein
the electric motor comprises a BLDC motor having a three-phase Y-connection method, a 12-pole-9 slot, or an 8-pole-6 slot structure, and
the plurality of coils which are three-phase (U, V, W) coils are split into and wound on nine or six teeth and form a series connection circuit or parallel connection circuit for each phase of U, V, and W phases.

8. A water pump comprising:
a pump cover in which an inlet through which a fluid is introduced and a side outlet through which the introduced fluid is discharged are connected through a fluid flow passage;
a cylindrical body case coupled to a lower portion of the pump cover;
an upper cover coupled to seal a lower portion of the body case to form a space inside the body case;
a rotor rotatably supported above the fluid flow passage inside the body case;
an impeller integrally formed with the rotor on an upper side of the rotor;
a stator arranged below the fluid flow passage inside the body case to face the rotor to generate a rotating magnetic field to rotate the rotor; and
a heat dissipation molding part surrounding the upper portion of the stator to waterproof and insulate the stator and integrating the stator with the body case and the upper cover, wherein
an air gap forming part of a thin film extending from the heat dissipation molding part is arranged on a front surface of the stator facing the rotor.

9. The water pump of claim 8, wherein the stator comprises:
an integrated stator core having a plurality of teeth arranged in an annular form at intervals and an annular back yoke that interconnects the plurality of teeth to form a magnetic circuit;
a bobbin made of insulating material, which is coupled to an upper portion of the stator core and in which a plurality of teeth coupling joints protrude, the plurality of teeth being inserted into the plurality of teeth coupling joints;
a plurality of coils assembled to an outer circumferential surfaces of the plurality of teeth coupling joints, respectively; and
an auxiliary printed circuit board (PCB) having a plurality of through-holes into which the plurality of teeth-coupling joints are inserted, wherein the plurality of coils are coupled to the plurality of teeth coupling joints protruding through the plurality of through-holes when coupled to the upper portion of the bobbin so as to be mounted on an upper surface thereof, and a plurality of conductive patterns for interconnecting the plurality of coils so as to form a three-phase Y-connection-type neutral point (N) are formed on the upper surface thereof.

10. The water pump of claim 9, wherein, when the plurality of coils, which are the three-phase (U, V, W) coils are split into and wound on nine teeth and constitute a parallel connection circuit for each phase of U, V, and W phases, the plurality of conductive patterns comprise:
first to third conductive patterns respectively arranged outside the auxiliary printed circuit board (PCB) and connected to start lines of the three-phase (U, V, W) coils mounted on the upper surface of the auxiliary printed circuit board (PCB) so as to configure a parallel connection circuit for each phase; and
a circular conductive pattern arranged around a through-hole formed in a central portion of the auxiliary printed circuit board (PCB) and having an end line of the three-phase (U, V, W) coils connected in common to form a Y-connection-type neutral point (N) of the three-phase (U, V, W) coils.

11. The water pump of claim 9, wherein the bobbin comprises:
a plurality of teeth coupling joints coupled to the outside of the plurality of teeth so as to surround the outer circumferential surface to which the coils of each of the plurality of teeth are wound; and
an annular flange connecting the plurality of teeth coupling joints, wherein
each of the plurality of teeth coupling joints has a through-hole through which the plurality of teeth of the stator core are combined to expose a front end thereof.

12. The water pump of claim 8, wherein the heat dissipation molding part is filled, from the upper portion of the stator, between the inner circumference of the body case and the annular protrusion protruding from the center of the upper cover to define the fluid flow passage, and includes insulating heat dissipation composite materials capable of increasing insulation and heat dissipation performance.

13. The water pump of claim 8, wherein
the rotor and the stator form an axial gap-type electric motor, and
the electric motor comprises a BLDC motor having a three-phase Y-connection method, a 12-pole-9 slot, or an 8-pole-6 slot structure, and the plurality of coils which are three-phase coils (U, V, W) are split into and wound on nine or six teeth and form a series connection circuit or parallel connection circuit for each phase of U, V, and W phases.

14. The water pump of claim 8, further comprising:
a support shaft having a lower end portion fixed to the upper cover through a groove inside an annular protrusion protruding from a center of the upper cover;
a bearing housing extending from the center of the rotor support supporting the rotor to the inside of the groove of the annular protrusion; and
a sleeve bearing installed at an inner circumferential portion of the bearing housing to rotatably support the rotor about the support shaft.

15. The water pump of claim 8, wherein the magnet of the rotor is an open structure exposed to the fluid, and the magnet of the rotor is a ferrite magnet.
